(19) United States
(12) Patent Application Publication
(10) Pub. No.: US 2019/0267820 A1
(43) Pub. Date: Aug. 29, 2019

(54) FOLDABLE CHARGING DEVICE

(71) Applicant: AVer Information Inc., New Taipei City (TW)

(72) Inventor: Chun-Hung LEE, New Taipei City (TW)

(21) Appl. No.: 16/043,171

(22) Filed: Jul. 24, 2018

(30) Foreign Application Priority Data
Feb. 23, 2018 (TW) 107106228

(51) Int. Cl. H02J 7/00

(52) U.S. Cl. CPC H02J 7/0042; H02J 7/0027

(57) ABSTRACT

A foldable charging device includes a rear panel, a first side panel module, a middle partition module, and a plurality of inner supporting plates. The first side panel module includes a first side panel fixing portion fixed to the rear panel and a first side panel moving portion pivotally connected to the first side panel fixing portion. The middle partition module includes a middle partition fixing portion fixed to the rear panel and a middle partition moving portion pivotally connected to the middle partition fixing portion. The inner supporting plates are rotatably coupled to the rear panel or the middle partition fixing portion.

### RELATED APPLICATIONS

This application claims priority to Taiwan Application Serial Number 107106228, filed Feb. 23, 2018, which is herein incorporated by reference.

### TECHNICAL FIELD

The present disclosure generally relates to a charging device. More particularly, the present disclosure relates to a foldable charging device.

### BACKGROUND

In recent years, due to the rapid development of electronics and information industries, the mobile electronic products have also become increasingly popular. With the increasing market share of mobile electronic devices, e.g. tablet computers and notebook computers, the mobile electronic devices are widely used in various industry or trade. Therefore, in order to charge these tablet computers and notebook computers, charging device suppliers have to arrange and provide many charging devices and locations for users.

Charging cabinet came into being. The charging cabinet can provide students and teachers with a better charging solution in schools to charge and store a large number of mobile devices at the same time. The charging cabinet can also charge a large number of mobile devices and test these mobile devices at the same time for industrial production needs.

The charging cabinet can accommodate a large number of mobile devices and charge the same, however the charging cabinet is also necessary to occupy a relatively large space for storage. Such a large charging cabinet can provide a very good space utilization rate for charging these mobile devices. However, when the charging cabinet is transported, the charging cabinet also occupies a very large space. The large charging cabinet may cause a higher shipping cost, and the large charging cabinet can also increase the difficulty of transportation.

Therefore, there is a need to provide a charging cabinet that can save the transportation space and is easy to install and use.

### SUMMARY

One objective of the embodiments of the present invention is to provide a foldable charging device able to save the transportation space and easy to install and use.

To achieve these and other advantages and in accordance with the objective of the embodiments of the present invention, as the embodiment broadly describes herein, the embodiments of the present invention provides a foldable charging device includes a rear panel, a first side panel module fixed to the rear panel, a middle partition module fixed to the rear panel, and a plurality of inner supporting plates rotatably connected to the rear panel or the middle partition module. The first side panel module includes a first side panel fixing portion fixed to the rear panel and a first side panel moving portion pivotally connected to the first side panel fixing portion. The middle partition module includes a middle partition fixing portion fixed to the rear panel, and a middle partition moving portion pivotally connected to the middle partition fixing portion. The inner supporting plates are rotatably connected to the rear panel or the middle partition fixing portion. The first side panel module and the middle partition module are folded to form at least one storage room for accommodating the inner supporting plates.

The foldable charging device further includes a foldable floor module fixed to the rear panel, and the foldable floor module includes a back floor panel fixed to the rear panel and a front floor panel pivotally connected to the back floor panel.

The foldable charging device further includes a front door pivotally connected to the first side panel moving portion. The foldable charging device further includes a second side panel pivotally connected to the rear panel. The foldable charging device further includes a front auxiliary door pivotally connected to the second side panel to allow the front auxiliary door and the second side panel folding on a side, opposite to the storage room, of the rear panel.

The foldable charging device further includes an upper cover pivotally connected to the rear panel. The foldable charging device further includes a set of feet removably connected to the foldable floor module.

In one embodiment, the inner supporting plates includes a plurality of first inner supporting shelves to support power supply devices and a plurality of second inner supporting shelves to support mobile devices.

In one embodiment, the foldable floor module further includes a bendable safety flap to increase transportation and assembly safety for the foldable charging device.

In one embodiment, the foldable floor module further includes at least one sliding rail to slidably connect to the set of feet and a hand screw for securing the set of feet to foldable floor module.

Hence, the foldable charging device can be effectively folded for transportation and easily assembled to greatly reduce the transportation cost thereof. In addition, the foldable charging device can be conveniently installed and used.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a schematic perspective view showing a foldable charging device according to one embodiment of the present invention;

FIG. 2 illustrates a schematic perspective view showing a foldable charging device according to one embodiment of the present invention in a folded mode;

FIGS. 3A to 3C illustrate unfolding steps of a foldable charging device according to one embodiment of the present invention;

FIG. 4 illustrates a schematic perspective view showing a bendable safety flap of a foldable charging device according to one embodiment of the present invention in a folded mode; and

FIG. 5 illustrates a schematic perspective view showing a spring positioning module and a fixing buckle of a foldable charging device according to one embodiment of the present invention in a folded mode.

### DETAILED DESCRIPTION OF THE PREFERRED EMBODIMENT

The following description is of the best presently contemplated mode of carrying out the present disclosure. This description is not to be taken in a limiting sense but is made merely for the purpose of describing the general principles of the invention. The scope of the invention should be determined by referencing the appended claims.

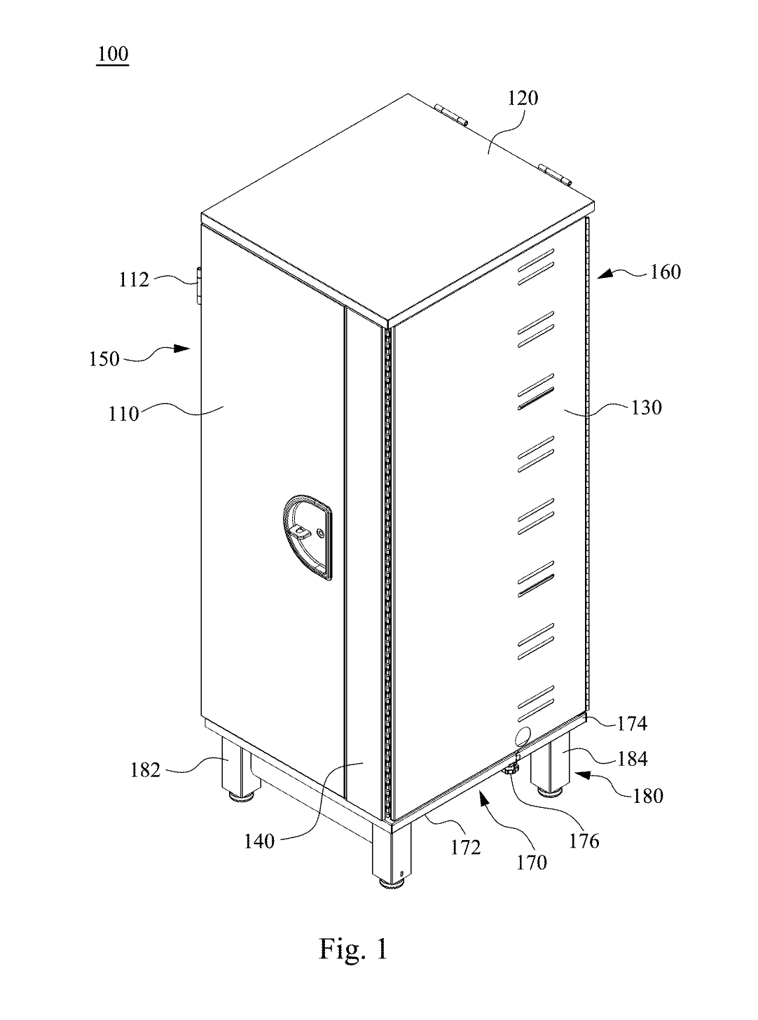

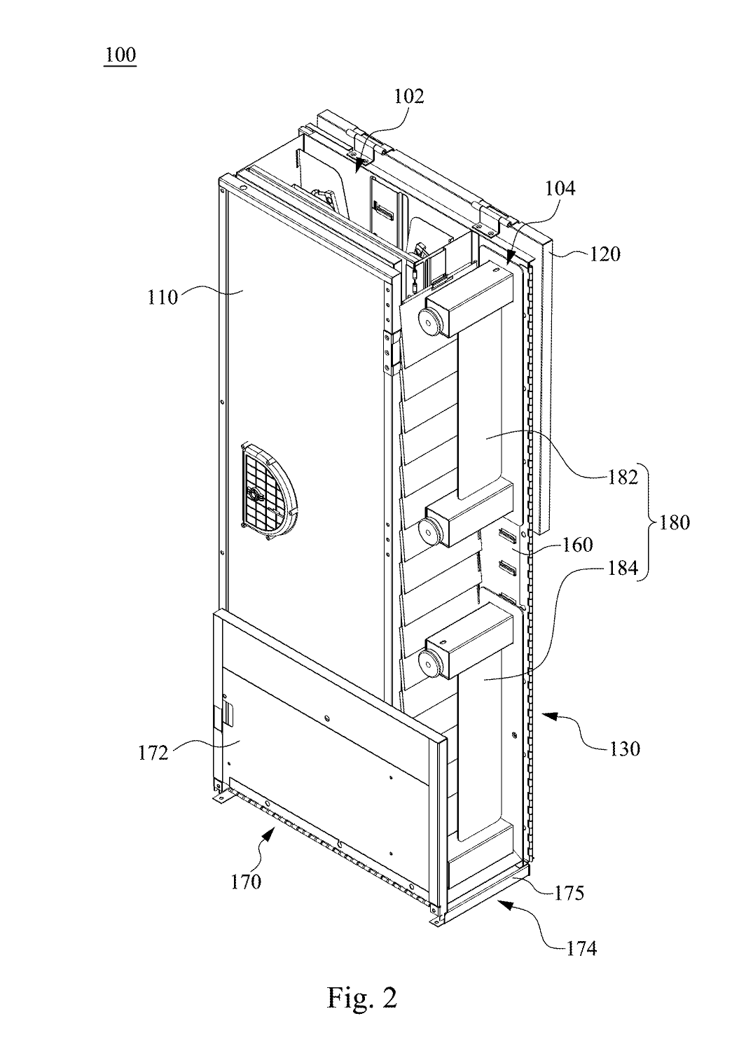

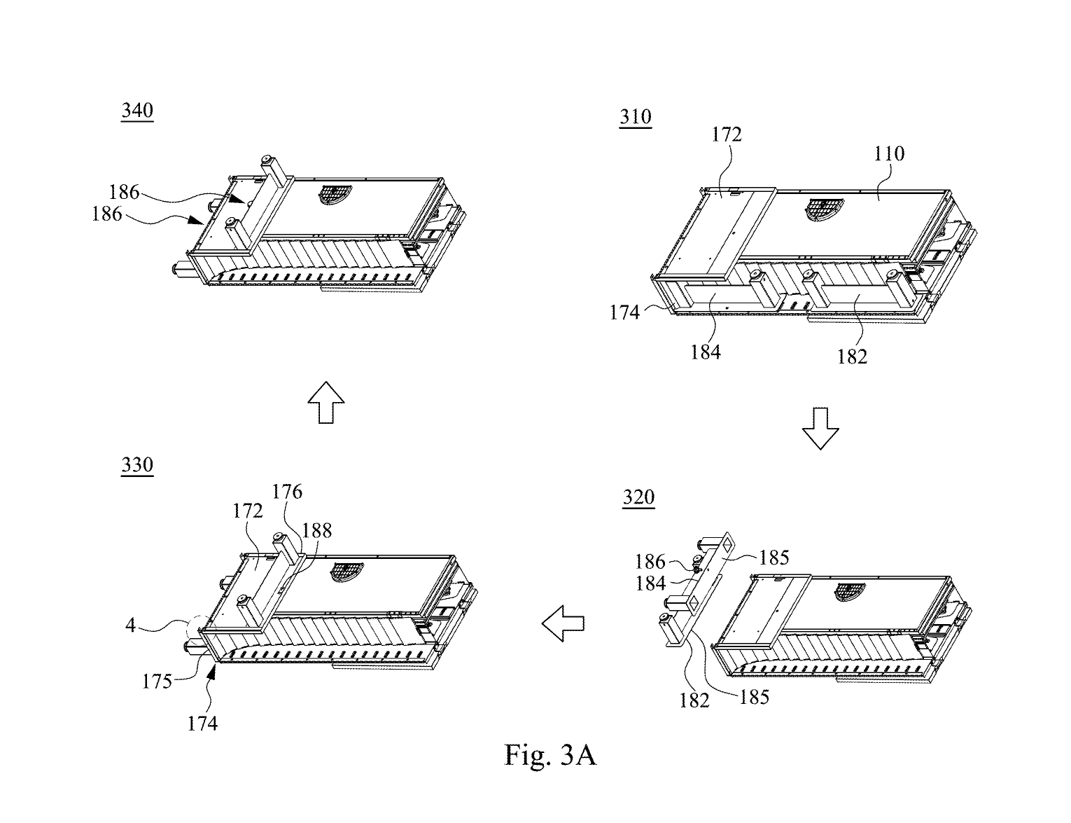

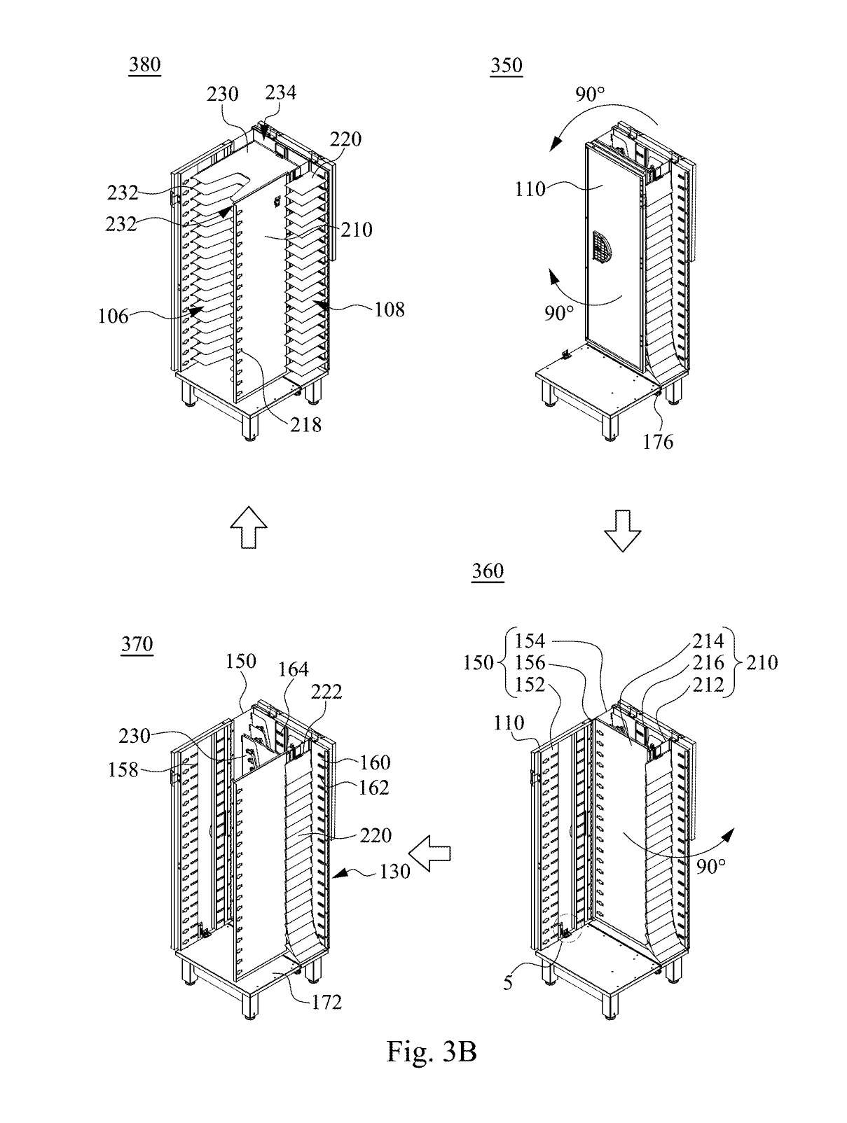

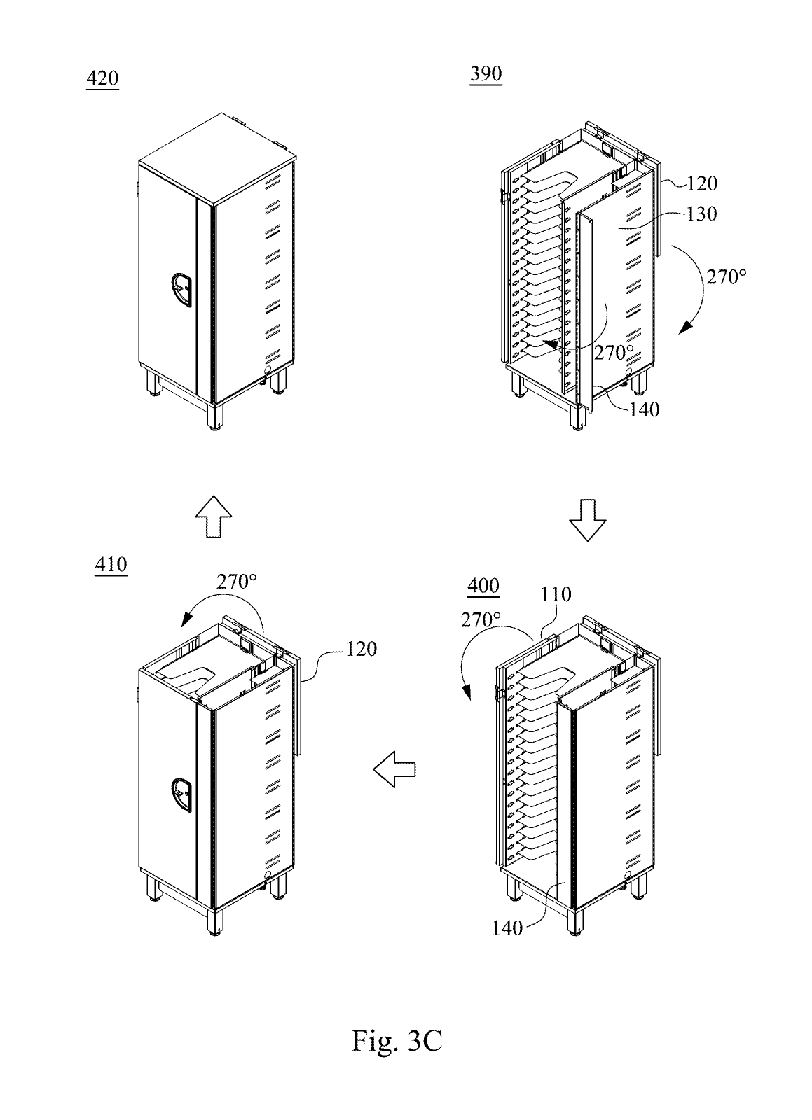

FIG. 1 illustrates a schematic perspective view showing a foldable charging device according to one embodiment of the present invention, FIG. 2 illustrates the foldable charging device in a folded mode, and FIGS. 3A to 3C illustrate unfolding steps of the foldable charging device according to one embodiment of the present invention.

As shown in FIGS. 1, 2 and 3A to 3C, the foldable charging device 100, e.g. a foldable charging cabinet, a foldable charging moving cabinet or a foldable charging car, includes a front door 110, an upper cover 120, a first side panel module, a second side panel, a rear panel 160, a foldable floor module 170, a middle partition module 210 and a set of feet 180. The first side panel module is, for example, a left door module 150 in the drawings, and the second side panel is, for example, a right door panel 130 in the drawing.

The left door module 150 is fixed to the rear panel 160, and the left door module 150 includes a left door fixing portion 154 fixed to the left side of the rear panel 160, and a left door moving portion 152 pivotally connected to the left door fixing portion 154.

The middle partition module 210 is also fixed to the rear panel 160, and the middle partition module 210 includes a middle partition fixing portion 212 fixed to the rear panel 160, and the middle partition moving portion 214 pivotally connected to the middle partition fixing portion 212.

In addition, the foldable floor module 170 is also fixed to the rear panel 160, and the foldable floor module 170 includes a back floor panel 174 fixed to the rear panel 160, and a front floor panel 172 pivotally connected to the back floor panel 174.

The aforementioned term “pivotally connected to” means that the panels are connected with a hinge, e.g. hinge 112, hinge 156 or hinge 216, or the like so that the panels can be relatively rotated or positioned.

The foldable charging device 100 further includes a plurality of inner supporting plates pivotally connected to the rear panel 160 or the middle partition fixing portion 212. Refer to FIG. 3B. In step 380, the first inner supporting shelves 220 is pivotally connected to the middle partition fixing portion 212 to support the power supply device. In addition, the second inner supporting shelves 230 is pivotally connected to the rear panel 160 to support the mobile devices, e.g. mobile phones, tablet computers or notebook computers.

Refer to FIG. 2. While the left door module 150 and the middle partition module 210 are folded, a first storage room 102 and a second storage room 104 are formed. The first storage room 102 can store the second inner supporting shelves 230 therein, and the second storage room 104 can store the first inner supporting shelves 220 and the set of feet 180 therein. Therefore, the volume of the folded foldable charging device 100 is reduced about ⅔ compared to the volume of the foldable charging device 100 in a use mode. Therefore, the folded foldable charging device 100 can be transported more easily so as to further reduce the transportation cost and improve the transportation efficiency thereof. In addition, the foldable charging device 100 can effectively achieve a purpose of energy saving and carbon reduction.

The front door 110 is pivotally connected to the left door moving portion 152 with the hinge 112 and the right door panel 130 is also pivotally connected to the rear panel 160.

In one embodiment, the foldable charging device 100 further includes a front auxiliary door 140 pivotally connected to the right door panel 130 to allow the front auxiliary door 140 and the right door panel 130 being folded on one side of the rear panel 160 opposite to the storage room.

In addition, the upper cover 120 is pivotally connected to rear panel 160, and able to be folded on the side of the rear panel 160 opposite to the storage room. For example, the upper cover 120 can be stored at a rear side of the rear panel 160, the front auxiliary door 140 and the right door panel 130. Alternatively, the upper cover 120 can be stored between the right door panel 130 and the rear panel 160 at a rear side without departing from the spirit and scope of the invention.

In one embodiment, the set of feet 180 includes forefeet 182 and rear feet 184, the forefeet 182 and the rear feet 184 are respectively fixed on the front floor panel 172 and the back floor panel 174.

In one embodiment, the set of feet 180 further includes moving wheels to form a foldable moving charging device so as to easily move the foldable charging device 100.

In one embodiment, the set of feet 180 further includes power wheels to form a foldable charging car to further conveniently move the foldable charging device 100.

In one embodiment, referring to step 320 to step 340 of FIG. 3A, the front floor panel 172 includes a sliding rail 176, and the forefeet 182 can slide into the sliding rail 176 with the foot supporting plate 185. Subsequently, the forefeet 182 are fixed on the front floor panel 172 by hand screws 186. The sliding rail 176 can be formed by bending two sides of the sheet metal of the front floor panel 172.

In addition, the back floor panel 174 includes sliding rail 175, the rear feet 184 can slide into the sliding rail 175 with the foot supporting plate 185. Subsequently, the rear feet 184 are fixed to the back floor panel 174 by the hand screws 186. The sliding rail 175 can be formed by bending two sides of the sheet metal of the back floor panel 174.

Furthermore, the front floor panel 172 and the back floor panel 174 may be further equipped with a stopping structure 188. After the foot supporting plate 185 slid into the sliding rail, the stopping structure 188 can limit the foot supporting plate 185 to prevent the foot supporting plate 185 from sliding out of the sliding rail. The stopping structure 188 is, for example, a pressing protrusion of the sheet metal, and a corresponding slot can be formed on the foot supporting plate 185 to limit the movement of the foot supporting plate 185.

Further referring to step 310 to step 420 of FIGS. 3A to 3C, the foldable charging device 100 is unfold from a folded mode to a use mode. In step 310, the foldable charging device 100 is under a folded mode so that the foldable charging device 100 can be transported with a smaller volume to save the space and achieve the purpose of energy saving and carbon reduction.

In step 320, the forefeet 182 and the rear feet 184 are taken out. In step 330, the forefeet 182 and the rear feet 184 are slid into the front floor panel 172 and the back floor panel 174. In step 340, the hand screws 186 are utilized to fix the forefeet 182 and the rear feet 184 on the front floor panel 172 and the back floor panel 174.

Subsequently, the front floor panel 172 is rotated with respect to the back floor panel 174 to unfold the foldable floor module 170. In step 350, the foldable charging device 100 is rotated about 90 degrees to stand on the ground, and the front door 110 and the left door moving portion 152 of the left door module 150 are rotated to the left side. In step 360, the left door moving portion 152 is fixed on the front floor panel 172. Subsequently, the middle partition moving portion 214 of the middle partition module 210 is rotated to the right side. In step 370, the middle partition module 210 is fixed on the front floor panel 172. In step 380, the first inner supporting shelves 220 and the second inner supporting shelves 230 are respectively fixed on the rear panel 160, the left door module 150 and the middle partition module 210.

In one embodiment, the left door module 150 and the middle partition module 210 are formed openings or protrusions thereon by pressing the sheet metal to form, for example, the fixed ring 158 to couple to shelf claws 232 of the second inner supporting shelves 230 at a desired position. In addition, the rear panel 160 can also form fixing holes 164 thereon to support the second inner supporting shelves 230. In one embodiment, the second inner supporting shelves 230 further include rotational axles 234 to rotatably couple to the rear panel 160.

Fixing buckles 162 are formed on the rear panel 160 by pressing the sheet metal to form protruding opening or protrusions to couple to the first inner supporting shelves 220. In one embodiment, the first inner supporting shelves 220 further include hinges 222 to rotatably couple to the middle partition fixing portion 212.

After the first inner supporting shelves 220 and the second inner supporting shelves 230 are installed, the foldable charging device 100 can form a mobile device storage room 106 to store the mobile device and a power supply storage room 108 to store the power supply.

In step 390, the right door panel 130 and the front auxiliary door 140 are rotated about 270 degrees from the rear side of the rear panel 160 and fixed to the foldable floor module 170. In step 400, the front door 110 is rotated about 270 degrees. In step 410, the upper cover 120 is rotated about 270 degrees and fixed on the top of the foldable charging device 100. In step 420, the foldable charging device 100 is completely unfolded. Therefore, the clever structure of the foldable charging device 100 can effectively save the transportation cost and users can conveniently perform the assembly even without any professional tools. The foldable charging device 100 can be folded, stored or transported in the reversed steps without departing from the spirit and scope of the present invention.

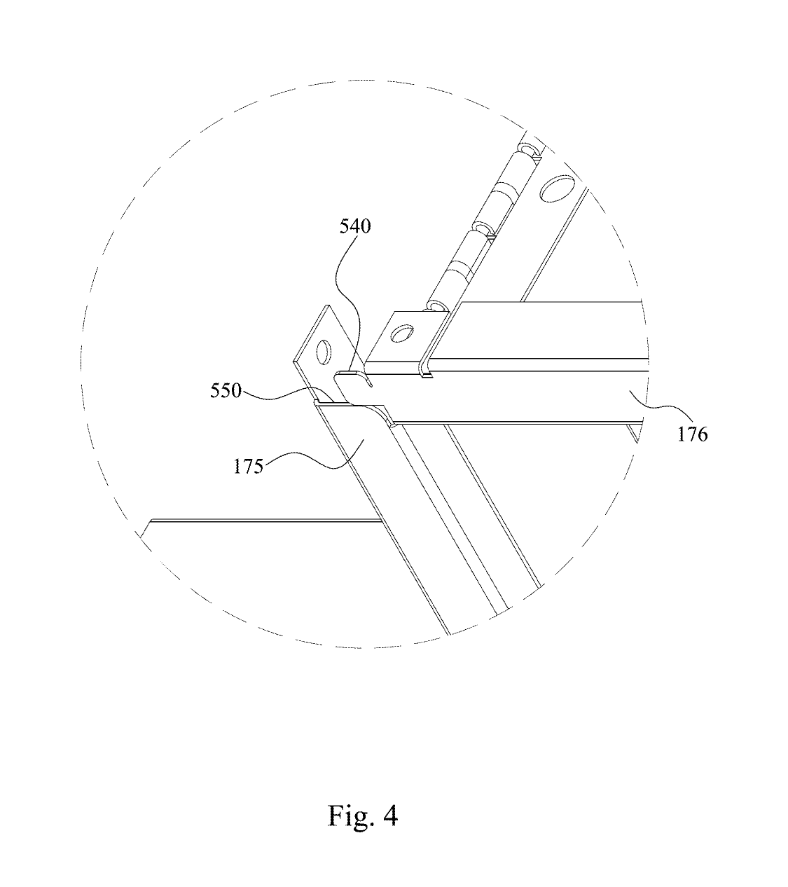

Furthermore, referring to FIG. 4, a bendable safety flap of a foldable charging device according to one embodiment of the present invention in a folded mode is illustrated. The foldable floor module 170 of the foldable charging device 100 further includes a bendable safety flap 540 formed in the sliding rail 176, and the sliding rail 175 further includes a limiting portion 550. While transporting the foldable charging device 100, the bendable safety flap 540 and the limiting portion 550 can restrict the relative rotation of the front floor panel 172 and the back floor panel 174 to increase the transportation and assembly safety. While assembling the foldable charging device 100, the bendable safety flap 540 can be bent first. And then, the front floor panel 172 can be rotated relative to the back floor panel 174, effectively avoiding any unintended shaking of the back floor panel 174 during transporting and assembling the foldable charging device 100. In addition, the same structure may also be equipped in any other hinge-connected panels to increase the safety of the assembly, but the present invention is not limited thereto.

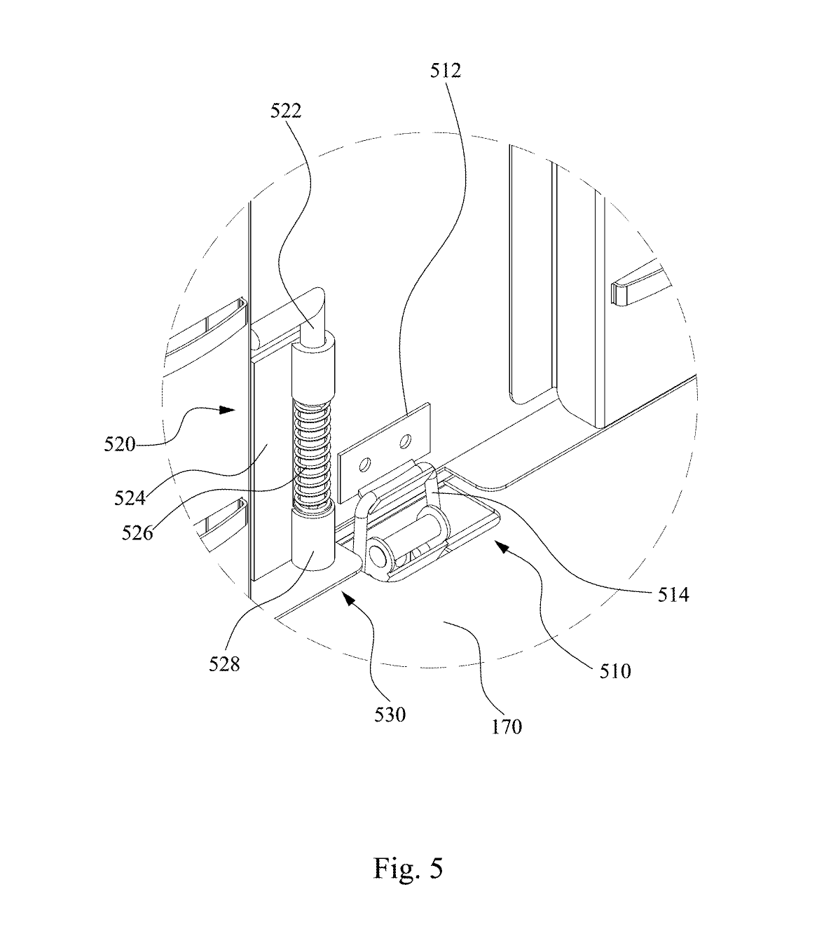

Further referring to FIG. 5, a spring positioning module and a fixing buckle of a foldable charging device according to one embodiment of the present invention in a folded mode is illustrated. As shown in FIG. 5, the fixing buckle 510 includes a fixing hook 512 and a fixed ring 514 to fix the left door moving portion 152, the right door panel 130 or the middle partition moving portion 214 on the foldable floor module 170 and the fixing buckle 510 can also fix the same to the upper cover 120.

For conveniently installing the foldable charging device 100, the foldable charging device 100 can further include a spring positioning module 520 to position the left door moving portion 152, the right door panel 130 or the middle partition moving portion 214 on the foldable floor module 170 while the same being rotated to a predetermined position.

The spring positioning module 520 includes a positioning pin 522, a supporting base 524 and a spring 526 to allow the spring positioning module 520 passing through a first opening 528, a second opening 530 of the foldable floor module 170 to fix the moving portion or panel to the predetermined position of the foldable floor module 170. In addition, a fixing buckle 510 can fix the moving portion or panel to the foldable floor module 170 to further improve the stability and the safety of the foldable charging device 100.

Accordingly, the foldable charging device can be effectively folded for transportation and easily assembled so that the transportation cost of thereof can be greatly reduce and the foldable charging device can be conveniently installed.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A foldable charging device, comprising:
a rear panel;
a first side panel module fixed to the rear panel, wherein the first side panel module comprises a first side panel fixing portion fixed to the rear panel and a first side panel moving portion pivotally connected to the first side panel fixing portion;
a middle partition module fixed to the rear panel, wherein the middle partition module comprises a middle partition fixing portion fixed to the rear panel, and a middle partition moving portion pivotally connected to the middle partition fixing portion; and
a plurality of inner supporting plates rotatably connected to the rear panel or the middle partition fixing portion, wherein the first side panel module and the middle partition module are folded to form at least one storage room for accommodating the inner supporting plates.

2. The foldable charging device of claim 1, further comprising a foldable floor module fixed to the rear panel, wherein the foldable floor module comprises a back floor panel fixed to the rear panel and a front floor panel pivotally connected to the back floor panel.

3. The foldable charging device of claim 2, further comprising a front door pivotally connected to the first side panel moving portion.

4. The foldable charging device of claim 3, further comprising a second side panel pivotally connected to the rear panel.

5. The foldable charging device of claim 4, further comprising a front auxiliary door pivotally connected to the second side panel to allow the front auxiliary door and the second side panel folding on a side, opposite to the storage room, of the rear panel.

6. The foldable charging device of claim 5, further comprising an upper cover pivotally connected to the rear panel.

7. The foldable charging device of claim 6, further comprising a set of feet removably connected to the foldable floor module.

8. The foldable charging device of claim 7, wherein the inner supporting plates comprises a plurality of first inner supporting shelves to support power supply devices and a plurality of second inner supporting shelves to support mobile devices.

9. The foldable charging device of claim 8, wherein the foldable floor module further comprises a bendable safety flap to increase transportation and assembly safety of the foldable charging device.

10. The foldable charging device of claim 9, wherein the foldable floor module further comprises at least one sliding rail to slidably connect to the set of feet and a hand screw for securing the set of feet to foldable floor module.
